(19) United States
(12) Patent Application Publication
(10) Pub. No.: US 2025/0073736 A1
(43) Pub. Date: Mar. 6, 2025

(54) PEPPER SPRAY DEVICE WITH INSERT-MOLDED SOFT TOUCH GRIP

(71) Applicant: Sabre Security Equipment Corporation, Fenton, MO (US)

(72) Inventor: Louis F. Riley, Conway, AR (US)

(21) Appl. No.: 18/461,102

(22) Filed: Sep. 5, 2023

(51) Int. Cl. B05B 15/63

(52) U.S. Cl. CPC B05B 15/63

(57) ABSTRACT

Pepper spray devices with insert-molded soft touch grips. The soft touch grip is disposed on an outer surface of a body for operatively receiving a product cannister. The soft touch grip forms a soft gripping surface on an outer surface of the body that is sized and shaped to conform to the shape of a user's palm and fingers wrapped around the outer surface of the body. The soft touch grip includes a front grip pad and a rear grip pad, each disposed in a respective recess in the outer surface of the body. The front and rear grip pads are overmolded into the recesses. One or more undercuts in the body mechanically secure the soft touch grip to the body.

### CROSS REFERENCE TO RELATED APPLICATIONS

This application is related to co-pending U.S. patent application Ser. No. 18/125,370 filed Mar. 23, 2023, and U.S. patent application Ser. No. 18/125,369 filed Mar. 23, 2023. The contents of each of these patent documents is incorporated herein by reference in its entirety.

### BACKGROUND OF THE INVENTION

The invention generally relates to a pepper spray device, and more specifically to a pepper spray device with an insert-molded soft touch grip.

Pepper spray devices typically have a body made of hard plastic and have an outer grip surface formed by the hard plastic. This can cause the pepper spray device to be hard to the touch and ergonomically uncomfortable. Therefore, it would be desirable to have a pepper spray device with that is more ergonomically comfortable and/or is softer to the touch when gripped.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, pepper spray devices.

According to a nonlimiting aspect, a pepper spray device includes an insert-molded soft touch grip disposed on an outer of a body for operatively receiving a pepper spray cannister.

According to another nonlimiting aspect, a pepper spray device includes a body for operatively receiving a product cannister, and a soft touch grip forming a soft gripping surface on an outer surface of the body.

Technical aspects of a pepper spray device as described above preferably include the capability of providing a more comfortable and/or ergonomically suitable gripping surface for a user to grasp when gripping the body, for example, when dispensing pepper spray (or other chemical irritant) at an attacker.

These and other aspects, arrangements, features, and/or technical effects will become apparent upon detailed inspection of the figures and the following description.

### BRIEF DESCRIPTION OF THE DRAWINGS

FIG. 1 is a rear isometric view of a pepper spray device according to a nonlimiting embodiment of the invention.

FIG. 2 is a front isometric view of the pepper spray device.

FIG. 3 is a front exploded isometric view of the pepper spray device.

FIG. 4 is a front elevation view of the pepper spray device.

FIG. 5 is a left side elevation view of the pepper spray device, the right side elevation view being substantially a mirror image thereof along the longitudinal (vertical) axis.

FIG. 6 is a partial transverse sectional view of the main body of the pepper spray device as seen along line 6-6 in FIG. 4.

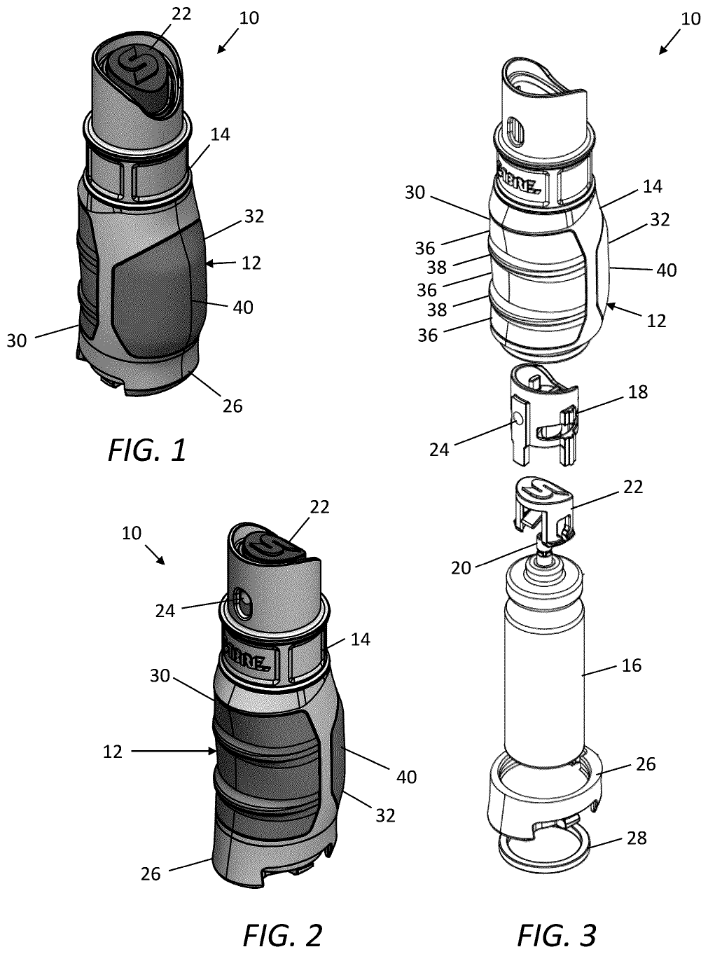

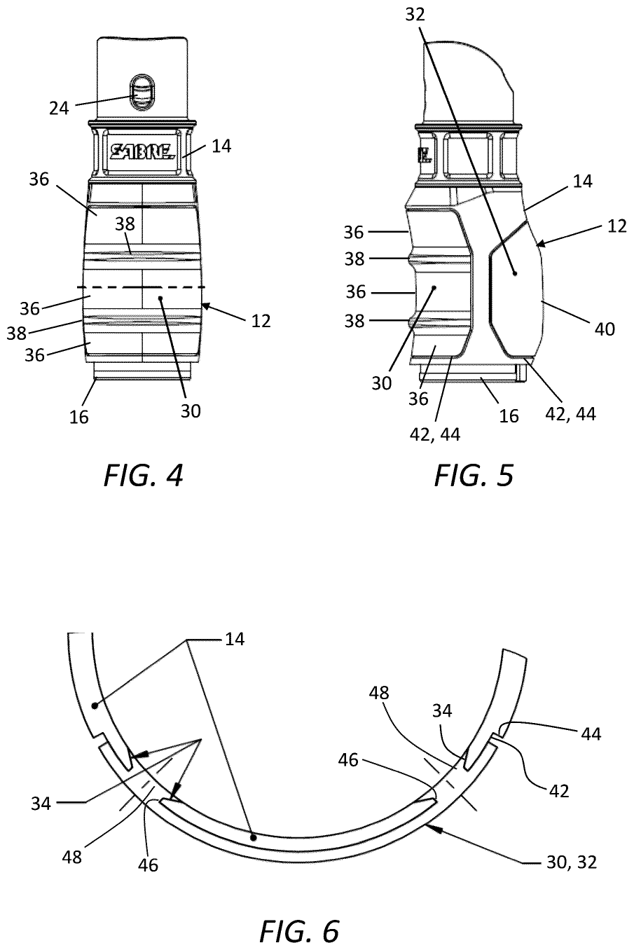

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of what is depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

Although the invention will be described hereinafter in reference to the pepper spray device shown in the drawings, it will be appreciated that the teachings of the invention are more generally applicable to a variety of types of personal protective devices that discharge a stream of chemical irritant, for example as a spray stream, to ward off a perceived attacker, such as, but not limited to, a spray device configured to spray mace or other sprayable chemical irritant.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the pepper spray device during its use and/or as represented in the drawings. All such relative terms are useful to describe the illustrated embodiment(s) but should not be otherwise interpreted as limiting the scope of the invention.

Turning now to the nonlimiting embodiment represented in the drawings, a pepper spray device 10 according to certain nonlimiting aspects of the invention includes a soft touch grip 12 to provide an ergonomic and comfortable gripping surface for a user when operating the pepper spray device. The pepper spray device 10 includes a body 14 with an interior cavity into which a canister 16 for holding and selectively dispensing a chemical irritant, such as a pepper spray. The pepper spray device 10 may be provided with the canister 16 or the canister 16 can be provided separately and later inserted into the body 14 for operation. The body 14 has a generally elongate axial shape extending from a top end to a bottom end and includes a generally cylindrical interior cavity extending longitudinally from the bottom end to the top end for the cannister. The cannister 16 has a generally cylindrical shape that is secured ion the interior cavity of the body 14 with a press fit. An actuator nozzle 18 is disposed at the top end of the body 14 and configured to depress and/or otherwise activate a product release valve mechanism 20 at the top end of the canister 16 when the canister is operatively positioned in the interior cavity of the body. When pushed downwardly toward the product release valve mechanism 20, the actuator nozzle 18 opens the product release valve mechanism and directs a stream of product inside the canister 16 released through the product release valve mechanism radially outwardly through a spray orifice 24. A safety 22 is preferably disposed between the actuator nozzle 18 and the product release valve mechanism 20 to prevent unintended activation and discharge of product from inside the canister 16 through the actuator nozzle 18. The pepper spray device 10 may also include an end cap 26 with threads that threadedly engage corresponding threads at the bottom end of the body 14 to retain the canister 16 inside the body 14. The pepper spray device 10 may also include a key ring 28 that is retained and/or captured by the end cap 26 and provides a user retention feature. Further aspects relative to details and functioning of various features of the body 14, actuator nozzle 18, end cap 26, key ring 28, and/or canister 16 may be found in co-pending U.S. patent application Ser. No. 18/125,370, filed Mar. 23, 2023, and Ser. No. 18/125,369, filed Mar. 23, 2023, the contents of which are incorporated herein by reference in their entireties.

In order to provide a more comfortable and/or ergonomically suitable gripping surface for the body 14 when the pepper spray device 10 is being operated by user, the soft touch grip 12 forms a soft outer grip surface disposed on an outer surface of the body 14. The soft outer grip surface is sized and shaped to conform to the shape of a user's palm and fingers when the user's hand is wrapped around the body 14 to operate the actuator nozzle 18. The soft touch grip 12 includes a front grip pad 30 and a rear grip pad 32. As a nonlimiting example, the body 14 is formed of a relatively hard first material, such as an injection molded polypropylene, whereas the front grip pad 30 and the rear grip pad 32 of the soft touch grip 12 are referred to as “soft touch” herein as a result of being formed of a relatively softer second material that is resilient and preferably slightly elastically deformable to the touch of a human hand gripping the body 14, but otherwise capable of maintaining its general shape under normal room temperature environment. The soft second material from which the front and rear grip pads 30 and 32 are formed is preferably a viscoelastic material. As a nonlimiting example, the soft second material is a thermoplastic elastomer, such as santoprene or other thermoplastic vulcanizate, however other soft resilient materials, such as neoprene, rubber, silicon rubber, or other elastomers, or leather, may be used. In addition, the body 14 may be formed of other relatively harder materials. The soft second material may be chemically bonded and/or mechanically bonded to the harder first material of the body 14. Preferably, the soft second material is a polymer with a hardness of 50-70 Shore A measured via the durometer scale in order to maximize gripability for user.

The front grip pad 30 is disposed on the radially outer surface of the front side of the body 14 axially below the spray orifice 24. The front grip pad 30 includes three horizontal circumferential finger channels 36 separated by two upper and lower horizontal circumferential ridges 38 defined on its outer surface. The upper and lower horizontal circumferential ridges 38 are spaced apart from each other axially along the longitudinal axis of the body 14. The upper horizontal circumferential ridge 38 is spaced axially downwardly from the top edge of the front grip pad 30, and the lower horizontal circumferential ridge 38 is spaced axially upwardly from the bottom edge of the front grip pad 30. Thus, an upper one of the finger channels 36 is defined between the top edge of the front grip pad 30 and the upper horizontal circumferential ridge 38, a lower one of the finger channels 36 is defined between the bottom edge of the front grip pad 30 and the lower horizontal circumferential ridge 38, and a middle one of the finger channels 36 is defined between the upper and lower horizontal circumferential ridges 38. Preferably, as best seen in FIG. 5, the outer surface of the front grip pad 30 also has a slightly convex curve along the longitudinal axis from the top edge to the bottom edge.

The rear grip pad 32 is disposed on the radially outer surface of the rear side of the body 14 diametrically opposite the front grip pad 30. The rear grip pad 32 forms a radially protruding hump 40 that is ergonomically shaped to fit into and generally conform to the concave shape of a cupped palm of the user's hand when the user is gripping the body 14. Preferably, as best seen in FIG. 5, the outer surface of the rear grip pad 32 has a convex shape along the longitudinal axis from the top edge to the bottom edge.

The front grip pad 30 wraps only partially around the front side of the body 14 in the transverse plane, and the rear grip pad 32 wraps only partially around the rear side of the body 14 in the transverse plane such that the adjacent longitudinal edges of the front and rear grip pads are spaced apart from each other.

Each of the front and rear grip pads 30 and 32 is disposed in a respective front or rear recess 42 in the radially outer surface of the body 14 so that the radially outer surfaces of the grip pads 30 and 32 are substantially flush with the adjacent exposed outer surface areas of the body 14. As best seen in FIG. 6, each front and rear recesses 42 has a peripheral stepped edge 44 that is recessed radially inwardly from the exposed outer surface of the body 14. The body 14 includes one or more undercuts 34 formed in each of the front and rear recesses 42 that mechanically retain the front and rear grip pads 30 and 32 in the respective recesses. 16. As represented in FIG. 6, the undercuts 34 are preferably defined within through-holes 46 in a wall of the body 14 and the material forming the grip pads 30 and 32 extends entirely through the wall. The grip pads 30 and 32 are represented in FIG. 6 as further comprising diverging securement portions 48 that are exposed at an internal surface of the body 14 and are preferably spaced apart from each other in a circumferential direction of the body 14.

The soft touch grip 12 is preferably incorporated into the body 14 by insert-molding. As a nonlimiting example, the front grip pad 30 and the rear grip pad 32 are over molded onto the body 14. For example, first the body 14 may be injected molded of a hard plastic to form the main structural unit of the body 14. Thereafter, the front grip pad 30 and the rear grip pad 32 can be injection molded (overmolded) onto the hardened formed body 14. The overmolding step of the front and rear grip pads 30 and 32 may be performed either in a secondary mold, or in a secondary processing step in the same mold in which the body 14 is molded. In either overmolding process, the soft second material is injection molded in a liquid state onto the body 14 into the recesses 42 after the hard first material after is in a suitable hardened solid state. The molten/liquid second material can flow and the undercuts 34 while it is being injection molded over the body 14. When the injection molded second material cools and solidifies, the soft second material solidifies around the undercuts 26 to form a mechanical bond that secures the front and rear grip pads 30 and 32 to the body 14. The soft second material may also be chemically bonded to the hard first material thereby forming a chemical bond between the body 14 and the front and rear grip pads 30 and 32.

As previously noted above, though the foregoing detailed description describes certain aspects of one or more particular embodiments of the invention, alternatives could be adopted by one skilled in the art. For example, the pepper spray device 10 and its components could differ in appearance and construction from the embodiments described herein and shown in the drawings, functions of certain components of the pepper spray device could be performed by components of different construction but capable of a similar (though not necessarily equivalent) function, and various materials could be used in the fabrication of the pepper spray device 10 and/or its components. As such, and again as was previously noted, it should be understood that the invention is not necessarily limited to any particular embodiment described herein or illustrated in the drawings.

1. A pepper spray device comprising:
a body for operatively receiving a product cannister; and
a soft touch grip forming a soft gripping surface on an outer surface of the body.

2. The pepper spray device of claim 1, wherein the soft touch grip is an insert-molded soft touch grip disposed on the outer surface of the body.

3. The pepper spray device of claim 1, wherein the soft touch grip is sized and shaped to conform to a shape of a user's palm and fingers wrapped around the outer surface of the body.

4. The pepper spray device of claim 1, wherein the soft touch grip comprises a front grip pad and a rear grip pad that is oppositely disposed on the body from the front grip pad.

5. The pepper spray device of claim 4, wherein the front grip pad is disposed in a front recess on the outer surface of the body and the rear grip pad is disposed in a rear recess on the outer surface of the body.

6. The pepper spray device of claim 4, wherein the front grip pad includes a plurality of finger channels configured to receive a user's fingers wrapped around the body.

7. The pepper spray device of claim 4, wherein an outer surface of the front grip pad has a convex curve along a longitudinal axis of the body.

8. The pepper spray device of claim 4, wherein the rear grip pad includes a radially protruding hump shaped to fit into and conform to a concave shape of a cupped palm of a user's hand gripping the body.

9. The pepper spray device of claim 1, where the body is formed of a first material and the soft touch grip is formed of a softer second material.

10. The pepper spray device of claim 9, wherein the second material is a viscoelastic material.

11. The pepper spray device of claim 9, wherein the second material is a thermoplastic elastomer.

12. The pepper spray device of claim 9, wherein the second material is santoprene.

13. The pepper spray device of claim 9, wherein the first material is a thermoplastic.

14. The pepper spray device of claim 9, wherein the first material is polypropylene.

15. The pepper spray device of claim 1, wherein the body includes one or more undercuts that mechanically secure the soft touch grip to the body.

16. The pepper spray device of claim 15, wherein the undercuts are defined within through-holes in a wall of the body and the soft touch grip extends entirely through the wall such that the soft touch grip comprises diverging securement portions that are exposed at an internal surface of the body.

17. The pepper spray device of claim 16, wherein the diverging securement portions are spaced apart from each other in a circumferential direction of the body.

18. The pepper spray device of claim 1, further comprising a cannister containing a chemical irritant.

19. The pepper spray device of claim 18, wherein the chemical irritant comprises pepper spray.

20. The pepper spray device of claim 18, further comprising an actuator for selectively dispensing product from within the cannister.
